(19) United States
(12) Patent Application Publication
(10) Pub. No.: US 2005/0173354 A1
(43) Pub. Date: Aug. 11, 2005

(54) Acoustic sensor for obstruction in a device circulating vortex-flow fluid

(75) Inventors: Patrick Binot, St-Maurice Cedex (FR); Alain Gadbois, Laval Quebec (CA); Georges Germa, Montreal Quebec (CA)

Correspondence Address: LESPERANCE & MARTINEAU, 1440 WEST, STE-CATHERINE ROOM 700, MONTREAL, QC, H3G1R8, CA

(73) Assignee: John Meunier Inc., St-Laurent, QC (CA)

(21) Appl. No.: 10/503,903

(22) PCT Filed: Feb. 25, 2002
(86) PCT No.: PCT/CA02/00233

(51) Int. Cl. B01D 17/038

(52) U.S. Cl. 210/788; 210/85; 210/512.1; 209/725; 209/726

(57) ABSTRACT

The invention concerns an acoustic sensor (44) for identifying obstruction of a circular grit trap for recycling fine sand in an industrial water clarifying plant. The circular grit trap comprises a cylindrical body having an outer wall and having at one first end a first sand-containing fluid inlet for receiving sludge and fine sand and a first overflow outlet of fluid not containing sand orthogonal to the fluid inlet, to evacuate said sludge, and at a second end a second sand-containing fluid underflow outlet coaxial with the first fluid outlet, to recover said sand. The acoustic sensor is sensitive to the noise radiated by the flow of the sand-containing fluid in the circular grit trap and is applied against the outer wall of the cylindrical body of the circular grit trap, in the plane of the fluid inlet but not coaxially therewith. Said acoustic sensor transmits a warning signal when an abnormal amplitude variation of sound level is measured in the bands of ⅓ octave centered on frequencies of 25 Hz or 200 Hz.

### FIELD OF THE INVENTION

This invention relates to physico-chemical systems for the treatment of industrial waters, and in particular to a system of acoustic detection in extreme bass frequencies of nonstandard densimetric fluctuations of a circulatory fluid having insoluble solid and liquid constituents involved in such a water treatment system.

### BACKGROUND OF THE INVENTION

In some industrial sectors, such as the industry of pulp and paper, of food processing, of metallurgy or of petrochemistry, a large quantity of service water is required. For cost purposes, this service water does not come from the drinking water network of a municipality, but rather directly from a natural source of untreated water such as a lake or a river. Consequently, the variations in the quality of the untreated water coming from natural water sources require pre-processing to clarify the water and to stabilize this clarified water, to a level below drinking water standards.

Such pre-processing of untreated water can for example comprise a sedimentation process in a water filtration unit comprising serially-linked sedimentation basins. In such a sedimentation process, a coagulation reagent can first be injected in the untreated water upstream the water filtration unit. The water then enters in a quick mixing basin where the colloidal particles are destabilized. The coagulated untreated water then passes to the step of the injection of a polymer and of fine sand. This sand serves as a ballast for the flocs. The addition of a polymer and moderate stirring accelerate the formation of bonds between the micro-flocs, the matter in suspension and the fine sand. Larger and denser flocs are thus formed. The flocs ballasted by the sand can sediment rapidly in the lamellar zone, and end up in the bin where the sludge is thickened. The clarified water is collected by a series of chutes, while the sludge located at the bottom of the bin is continuously pumped towards a hydrocyclone, allowing the separation of the sand and the flocs. The hydrocyclone thus has the function of reintroducing the sand in the injection basin and of evacuating the sludge. Indeed, the fine sand (typically between 20 and 300 micrometers of granulometry) is an important element in the good and efficient functioning of such a treatment system for industrial waters.

Thus, in European patent application published Nov. 8, 1995 under number 680,933 in the name of the French company “OTV Omnium de Traitements et de Valorisation”, there is described such a process for treating a flow of untreated water loaded with particles and colloids, in which the following steps are followed:
a) circulating this untreated water in a first zone called coagulation zone, which is kept turbulent and in which a coagulant reagent is mixed to this water in a controlled proportion;
b) circulating the coagulated flow;
c) adding fine sand, having a granulometry between 20 and 300 micrometers, in a second intermediate zone of flocculation and of maturation;
d) injecting a flocculating agent in this intermediate zone;
e) maintaining, in this intermediate zone, turbulences suitable to maintain this fine sand in suspension while the colloids or particles of the untreated water aggregate around the fine sand particles;
f) circulating the untreated water, including all the added fine sand and the colloids or particles aggregated thereto, in a third sedimentation zone, where a sedimented effluent is separated from the sludge consisting of the fine sand and of the aggregated colloids;
g) collecting the sludge;
h) extracting the fine sand from the sludge by a process notably of hydrocycloning;
i) recycling the fine sand upstream; and
j) extracting the sludge purged from the sand.

This water treatment process treats turbidity, color, olfactory and gustatory characteristics, algae proliferation, matter in suspension and metals.

A problem associated with such a sedimentation system exists when the hydrocyclone is clogged with the sludge, which prevents the fine sand from taking the underflow outlet of the hydrocyclone and which engenders reflux of the fine sand in the overflow outlet with the sludge which was intended to be separated from the fine sand. The sand being no longer recycled in the circuit, this engenders degradation of the water treatment process. For now, only the passage of the operator in a regular fashion in front of the hydrocyclone with visual inspections, allows the prevention of this type of problem, which represents high labour costs without mentioning non-guaranteed reliability.

In this context, it is known that the movement of a fluid in a duct produces a noise radiated in the range between 1 Hertz (Hz) and 100 kiloHz. The background noise generated by the pumps and the machinery is generally below 5,000 Hz, while higher sound frequencies, i.e. between 5,000 and 50,000 Hz, generally provide the sought-after clues concerning the fluid flow rate. Consequently, the known surveillance systems of radiated noise in a duct in which a fluid circulates, ignore frequencies inferior to 5,000 Hz.

### OBJECTS OF THE INVENTION

The main object of the invention is thus to offer a means for allowing the detection of early warning signals of clogging of the hydrocyclone of a treatment unit for industrial waters, before it happens, which allows the maintenance service to be alerted to remedy the situation before the start of the degradation of the water treatment process.

A more specific object is to provide such a detection means of early warning signals of clogging of this hydrocyclone, which will allow improvement of the control of nonstandard losses of the fine sand used for maintaining a process of sedimentation of untreated water with recycling of the sand, in optimal functioning mode.

A corollary object of the invention is to propose an improvement of the treatment unit of untreated water by sedimentation after ballasting with fine sand, as described in the European patent application No. EP 95400873.6 filed Apr. 19, 1995 in the name of the French company OTV, supra, and of which one of the co-inventors is also a co-inventor in the present patent application.

An important object of the invention is to ensure constant quality of the water clarified by the untreated water treatment unit described in application EP 95400873.6, supra, whatever the upstream conditions of the untreated water.

Other objects of the invention are that these detection means be easy to use, of low cost, reliable and easy to maintain.

### SUMMARY OF THE INVENTION

Given the object of the invention, provision is made to install an acoustic sensor against the outer wall of the vortex zone of the hydrocyclone of a water clarification unit for industrial waters, in order to measure the noise radiated in extreme bass frequencies (below 500 Hz) in the region of the hydrocyclone during separation of the sand and the sludge.

The invention notably relates to a device for acoustic control of densimetric fluctuations of a fluid comprising fine sand and sludge and able to circulate across a hydrocyclone, the hydrocyclone allowing the segregation of fine sand from the sludge of said fluid and comprising a tubular body having an outer wall and having, at a first end, an inlet of said fluid and a first sludge outlet transverse to said fluid inlet, and at a second end, a second sand outlet, said control device being formed of: a) an acoustic sensor, sensitive to noise radiated by the flow of said sandy fluid in the hydrocyclone and destined to be applied against the outer wall of said hydrocyclone body generally in the plane of its said fluid inlet, said acoustic sensor being sensitive at least to very low frequencies; and b) a microprocessor, linked in a functional fashion to said acoustic sensor and being for transmitting a warning signal when said acoustic sensor detects an amplitude variation of said radiated noise exceeding a threshold value.

Said warning signal can be transmitted when said acoustic sensor detects in high amplitude a waveband of ⅓ of octave centered at a frequency of 25 Hertz or of 200 Hz.

The invention also relates to a hydrocyclone for recycling fine sand used in an industrial water clarification unit, the hydrocyclone comprising: a) a tubular body having an outer wall and having a fluid inlet at a first end, to receive sludge and fine sand, a first sludge outlet transversal to said fluid inlet, to evacuate this sludge, and a second sand outlet at a second end, to reclaim said sand; b) an acoustic sensor, sensitive to the noise radiated by the flow of said fluid in the hydrocyclone and applied against said outer wall of said hydrocyclone body, generally in the plane of said fluid inlet, said acoustic sensor being sensitive at least to low frequencies between 25 and 500 Hertz; and c) a microprocessor, linked in a functional fashion to said acoustic sensor and being for transmitting a warning signal when said acoustic sensor detects an amplitude variation of said radiated noise exceeding a threshold value.

Said acoustic sensor could also be sensitive to the flow of said fluid across said first fluid (overflow) outlet. Said acoustic sensor will preferably occupy a position on said hydrocyclone forming an angle of about 45 degrees relative to a longitudinal axis formed by said fluid inlet. Said acoustic sensor can be a sub-centimetric microphone, and then further comprises a flexible elastomeric adaptor, anchoring said microphone to said outer wall of the hydrocyclone body.

The invention also relates to a method for determining parameters of flow of a fluid having solid and liquid constituents in a hydrocyclone, comprising the following steps: a) passing said fluid through an inlet of said hydrocyclone; b) creating a vortex inside said hydrocyclone, in order to obtain a segregation of said fluid in a first pasty constituent, evacuated through a first outlet of the hydrocyclone, and a second solid constituent, reclaimed through a second outlet of the hydrocyclone; c) detecting by means of an acoustic sensor the noise radiated by the flow of said fluid in the vortex of the hydrocyclone; d) subjecting said radiated noise to an analysis of hertzian frequencies, and isolating the frequencies within the range between 25 and 500 Hertz; e) assessing the amplitude of the variations of the sound level of said radiated noise in function of a given period of time; and f) transmitting a warning signal when said amplitude of the sound level variations of radiated noise exceeds a threshold value.

In the case where the solid constituent of said fluid comprises fine sand having a granulometry varying between 20 and 300 micrometers, said transmission of the warning signal could be differed until a waveband of ⅓ of octave centered at a frequency selected among the frequencies of 25 Hertz and 200 Hertz is isolated, at a level exceeding said threshold amplitude value.

The invention also relates to an electromagnetic control device for controlling densimetric fluctuations of a fluid having solid and liquid constituents able to circulate across a hydrocyclone, the hydrocyclone allowing the segregation of the solid constituent of the fluid and comprising a tubular body having, at a first end, a fluid inlet and a first outlet for the liquid constituent of said fluid transverse to said fluid inlet, and at a second end, a second outlet for the solid constituent of said fluid, said control device being formed of: a) electromagnetic means for remotely detecting an electromagnetic emission generated by the flow of the fluid in the hydrocyclone; b) a data processing unit, linked in a functional fashion to said electromagnetic means and being for transmitting a warning signal when said electromagnetic means detect a nonstandard amplitude variation of said electromagnetic emission.

### DESCRIPTION OF THE DRAWINGS

In the annexed drawings:

FIG. 1 is a vertical cross-section of a water clarification unit, comprising a fluid recirculation channel with a hydrocyclone;

FIG. 2 shows an enlarged elevational view of the hydrocyclone of FIG. 1;

FIG. 3 is a longitudinal broken cross-sectional view of the two opposite end portions of the hydrocyclone of FIG. 2, and showing the acoustic sensor according to the invention; and

FIG. 4 is a transverse cross-sectional view of the upper portion of the hydrocyclone, including the acoustic sensor and its electrical control box.

### DETAILED DESCRIPTION OF THE PREFERRED EMBODIMENT

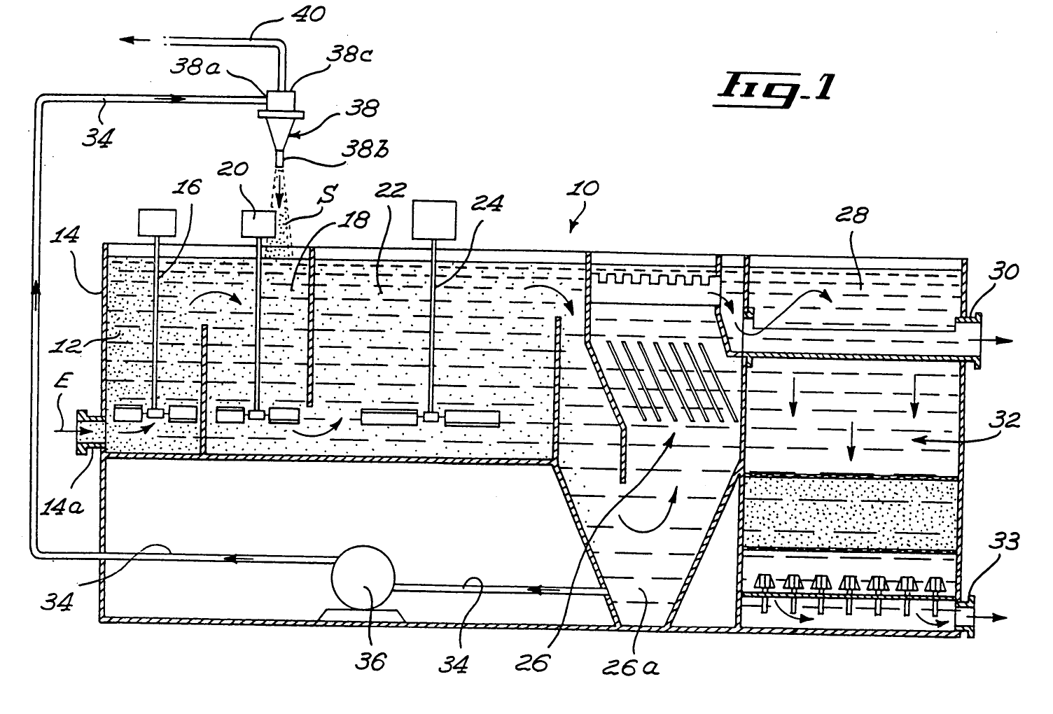

FIG. 1 of the drawings shows a treatment unit for industrial waters.

This unit 10 is for example prefabricated in stainless steel. Unit 10 supports a water clarification process comprising:
a) the coagulation and the flocculation aided by fine sand (having a granulometry inferior to 300 micrometers), which will encourage the formation of ballasted flocs and the increase in the precipitation speed of the flocs during sedimentation; and
b) lamellar sedimentation, which allows a significant decrease in the surface area of the sedimentation basin.

Unit 10 thus comprises at a first end a first coagulation basin 12. This basin 12 is fed with untreated water E through an inlet 14a provided at a section intermediate in height of a vertical wall 14 of unit 10. A coagulation reagent (not shown) is injected in the untreated water upstream unit 10. Through the instrumentality of a rotary motorized agitator 16, installed in the coagulation basin 12, the coagulated untreated water then passes in a second injection basin, 18, in which polymers (not shown) and fine sand S are injected in the coagulated untreated water to form flocs. Fine sand S serves as a ballast to the flocs. The addition of polymers and moderate stirring accelerate the formation of bonds between the micro-flocs, the matter in suspension and the fine sand. Under the influence of another motorized rotary agitator 20 installed in basin 18, migration occurs towards a third maturation basin 22, and under the influence of another agitator 24, the flocs ballasted by sand S sediment rapidly in a lamellar bowl 26.

The sludge formed of the flocs and of sand S sediment and accumulate under the influence of gravity in the bottom of bin 26A, while the clarified water is collected in an upper basin 28 in order to be evacuated through a washing water outlet 30 in order to be economically reclaimed thereafter. A portion of the clarified water can also be filtered by a gravitational filter 32, before being evacuated through a filtered water outlet 33 in the bottom of unit 10 and economically reclaimed thereafter.

A channel 34 provided with a circulatory pump 36 links the bottom of bin 26A to a point facing the upper surface of injection basin 18 spaced therefrom. A hydrocyclone 38 is installed at the upper end of channel 34, such that the sludge located at the bottom of bin 26A can be pumped continuously towards this hydrocyclone 38. Hydrocyclone 38 has the function of separating the flocs from sand S, and hence comprises an upstream inlet 38A, a first downstream outlet 38B, called underflow outlet, of the hydrocyclone, to return and economically reclaim sand S by vortex effect in injection basin 18, and a second downstream outlet 38C, called overflow outlet, of the hydrocyclone, to evacuate by vortex effect and throw out the sand-ridded flocs through another channel 40.

Outlet 38C forms a tubing, of which the upstream portion 39 of its vent has a restricted diameter, and thus forming a bottleneck relative to its opposite downstream portion. As illustrated in FIG. 3 of the drawings, this upstream portion 39 of overflow outlet tubing 38C, is swerved inwardly in body 42 of hydrocyclone 38 relative to inlet 38A, such that fluids coming from inlet 38A cannot penetrate through the upstream portion 39 of the overflow outlet 38C, unless they have travelled along baffles or vortical currents 41 in vortex 43 of hydrocyclone 38.

FIG. 2 shows a hydrocyclone 38, comprising a conical body 42 having an inner surface 42A and an outer surface 42B delimiting an inner conical vent 47. Inlet 38A is transversal to the longitudinal axis of conical body 42, while outlets 38B and 38C are coaxial to this longitudinal axis. Inlet 38A and sludge outlet 38B are coaxial to each other. Inlet 38A will for example be horizontal, while outlets 38B, 38C will for example be vertical.

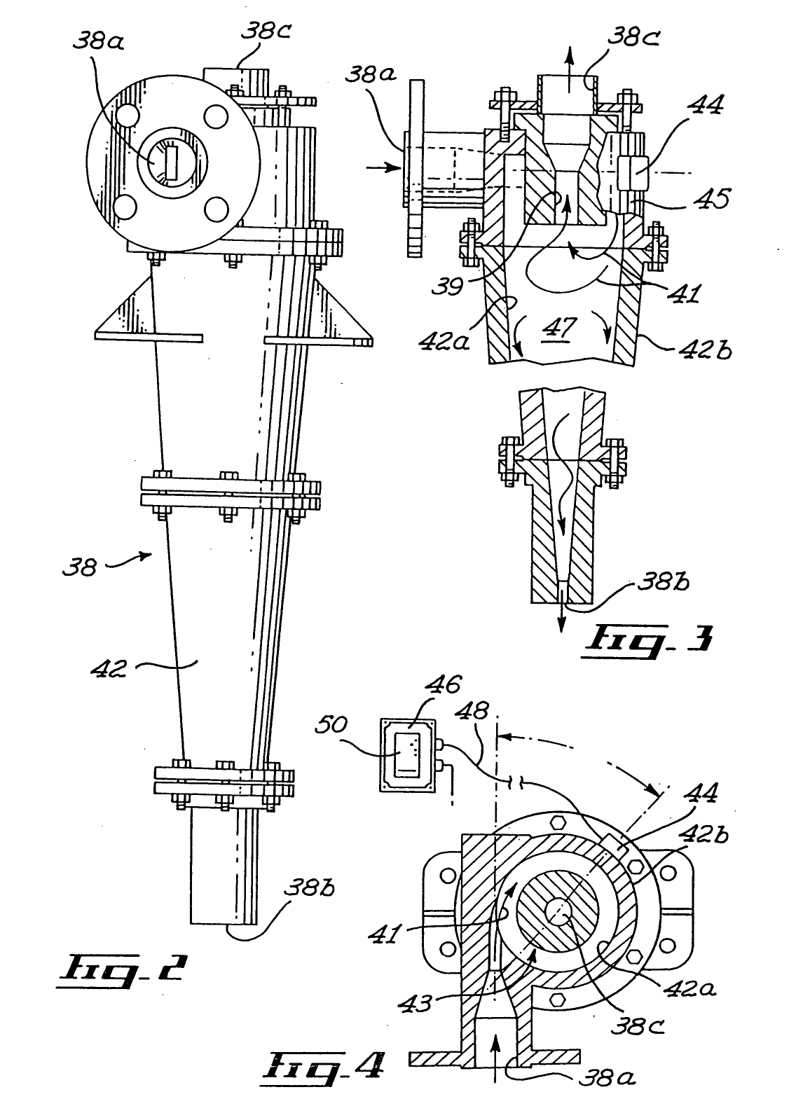

According to the invention, an acoustic sensor 44 (FIGS. 3 and 4) is installed against the outer wall 42B of the conical body and facing inlet 38A. This acoustic sensor 44 occupies the same transversal plane than inlet 38A of hydrocyclone 38, but is not coaxial with this inlet 38A. A surprising optimisation of the performance of acoustic sensor 44 is observed when the position of sensor 44 relative to the longitudinal axis of inlet 38A produces an angle of about 45 degrees. An electrical control box 46 is linked to this sensor 44 by an electric cable 48. This control box 46 can comprise a small microprocessor 50, which can control an alarm bell (not shown) when some predetermined acoustical parameters are reached.

Acoustic sensor 44 can then be formed of a microphone of about 0.6 centimetres, for example the MFS 100 model of the American company GREYLINE INSTRUMENTS, inc. (Massena, N.Y.). This MFS 100 model is efficient on a fluid duct of a minimal diameter of 6.5 millimetres. A switch in this microphone 44 will react to the noise radiated in the hydrocyclone 38 by the flow of fluid, when this noise will exceed an adjustable pre-established level, will detect it, amplify it, to then control a control relay. This microphone is installed on the outer wall 42B of the hydrocyclone, with a simple clamp; there is no direct contact with the circulating fluid, no obstruction therewith. There is no hole to be made in the wall of hydrocyclone 38. This microphone 44 is however modified to be sensitive to extreme bass frequencies, that is, below 500 Hz.

This microphone 44 can be applied on the outer wall 42B of the feed flute 45 of the hydrocyclone, and more particularly in vortex zone 43 as illustrated in FIGS. 3 and 4, through the instrumentality of a flexible elastomeric adaptor, for example in neoprene, in order to establish a quasi-contact with the various fluid flow zones of the hydrocyclone to monitor, all the while reducing to a minimum the contribution of background noise (such as pumps, agitators, compressors, etc.) to the level of this microphone. Microprocessor 50 can for example be provided with an analysis software having two 16-bits channels through the instrumentality of a programmable preamplifier; and a second microprocessor (not shown) could be used in parallel with the first one, and would be connected to a second channel of a data capture system through the instrumentality of an audiometer.

When hydrocyclone 38 gets clogged, a loss of fluid flow rate at the underflow outlet 38B can be noted, and so can a discharge of sand S through overflow outlet 38C. The fluid flow rate exerts an influence on the signature of the noise of the hydrocyclone, because the affluence and the concentration of sand in vortex zone 43 will provoke a particular signature detectable by acoustic sensor 44.

Various tests accomplished by means of this acoustic sensor 44 allowed to discover that, surprisingly, the spectral analysis of the signal at thirds of octave in real time of the acoustic signals coming particularly from vortex zone 43, but also to a lesser extent from the zone of the overflow outlet 38C, revealed amplitude fluctuations of the sound level relative to the normal acoustic signature of the noise radiated by fluid in the hydrocyclone, in very low-frequencies wavebands (below 500 Hz) during the clogging of the hydrocyclone. In the previous section of the background of the invention is mentioned that known systems for monitoring the noise radiated by the flow of a fluid in a duct, were developing in frequencies superior to 5 kHz, and hence ignored frequencies inferior to 500 Hz.

In particular, the co-inventors have detected in an unexpected fashion large amplitude variations of sound levels in the third of frequency octaves present in the range between 25 and 500 Hz, and in particular in the thirds of octave around 25 Hz or 200 Hz where the system seemed to enter in resonance, this being in the level particularly of vortex 43 or of the overflow outlet 38C of hydrocyclone 38. Such a situation allows the detection of the clogging of this hydrocyclone 38 even before the evacuation of sand S through overflow 38C starts, at the same time as the sludge.

The hydrocyclone 38 could be covered with elastomeric linings, for example in neoprene or in polyurethane.

Of course, the present system of acoustic detection of modifications of fluid flow parameters, is not limited to treatment of industrial waters with an hydrocyclone, but could extend to other similar domains, comprising particularly a fluid having immiscible solid constituents flowing in channels linked to a system creating vortical currents allowing separation of the solid constituent from the fluid. Fine sand, as used herein, does not exclude any insoluble granular material in the liquid of the circulatory fluid. Sludge, as used herein, can mean any sort of natural or non-natural debris, macro or microparticulate, bonded to each other in a more or less loose fashion to form a deformable group such as a paste or something similar.

1. Device for acoustic control of densimetric fluctuations of a fluid comprising fine sand and sludge and able to circulate across a hydrocyclone, the hydrocyclone allowing the segregation of fine sand from the sludge of said fluid and comprising a tubular body having an outer wall and having, at a first end, an inlet of said fluid and a first sludge outlet transverse to said fluid inlet, and at a second end, a second sand outlet, said control device being formed of:
a) an acoustic sensor, sensitive to noise radiated by the flow of said sandy fluid in the hydrocyclone and destined to be applied against the outer wall of said hydrocyclone body generally in the plane of its said fluid inlet, said acoustic sensor being sensitive at least to very low frequencies; and
b) a microprocessor, linked in a functional fashion to said acoustic sensor and being for transmitting a warning signal when said acoustic sensor detects an amplitude variation of said radiated noise exceeding a threshold value.

2. Control device according to claim 1,
wherein said warning signal is transmitted when said acoustic sensor detects in high amplitude a waveband of ⅓ of octave centered at a frequency of 25 Hertz.

3. Control device according to claim 1,
wherein said warning signal is transmitted when said acoustic sensor detects in high amplitude a waveband of ⅓ of octave centered at a frequency of 200 Hertz.

4. Hydrocyclone for recycling fine sand used in an industrial water clarification unit, the hydrocyclone comprising:
a) a tubular body having an outer wall and having a fluid inlet at a first end, to receive sludge and fine sand, a first sludge outlet transversal to said fluid inlet, to evacuate this sludge, and a second sand outlet at a second end, to reclaim said sand;
b) an acoustic sensor, sensitive to the noise radiated by the flow of said fluid in the hydrocyclone and applied against said outer wall of said hydrocyclone body, generally in the plane of said fluid inlet, said acoustic sensor being sensitive at least to low frequencies between 25 and 500 Hertz; and
c) a microprocessor, linked in a functional fashion to said acoustic sensor and being for transmitting a warning signal when said acoustic sensor detects an amplitude variation of said radiated noise exceeding a threshold value.

5. Hydrocyclone according to claim 4,
wherein said warning signal is transmitted when said acoustic sensor detects in high amplitude a waveband of ⅓ of octave centered at a frequency of 25 Hz.

6. Hydrocyclone according to claim 4,
wherein said warning signal is transmitted when said acoustic sensor detects in high amplitude a waveband of ⅓ of octave centered at a frequency of 200 Hz.

7. Hydrocyclone according to claim 4,
wherein said acoustic sensor is sensitive to the flow of said fluid across said first sludge outlet.

8. Hydrocyclone according to claim 7,
wherein said acoustic sensor occupies a position on said hydrocyclone forming an angle of about 45 degrees relative to a longitudinal axis formed by said fluid inlet.

9. Hydrocyclone according to claim 8,
wherein said acoustic sensor is a sub-centimetric microphone, and further comprising a flexible elastomeric adaptor, anchoring said microphone to said outer wall of the hydrocyclone body.

10. Hydrocyclone according to claim 4,
wherein said warning signal is transmitted when said acoustic sensor detects in high amplitude a waveband of ⅓ of octave centered at a frequency selected among the frequencies of 25 Hertz and 200 Hz.

11. Hydrocyclone according to claim 10,
wherein said acoustic sensor is sensitive to the flow of sludge across said first sludge outlet.

12. Hydrocyclone according to claim 11,
wherein said acoustic sensor occupies a position on said hydrocyclone forming an angle of about 45 degrees relative to a longitudinal axis formed by said fluid inlet.

13. Hydrocyclone according to claim 12,
wherein said acoustic sensor is a sub-centimetric microphone, and further comprising a flexible elastomeric adaptor, anchoring said microphone to said outer wall of the hydrocyclone body.

14. Method for determining parameters of flow of a fluid having solid and liquid constituents in a hydrocyclone, comprising the following steps:
a) passing said fluid through an inlet of said hydrocyclone;
b) creating a vortex inside said hydrocyclone, in order to obtain a segregation of said fluid in a first pasty constituent, evacuated through a first outlet of the hydrocyclone, and a second solid constituent, reclaimed through a second outlet of the hydrocyclone;
c) detecting by means of an acoustic sensor the noise radiated by the flow of said fluid in the vortex of the hydrocyclone;
d) subjecting said radiated noise to an analysis of hertzian frequencies, and isolating the frequencies within the range between 25 and 500 Hertz;
e) assessing the amplitude of the variations of the sound level of said radiated noise in function of a given period of time; and
f) transmitting a warning signal when said amplitude of the sound level variations of radiated noise exceeds a threshold value.

15. Method for determining parameters of flow of a fluid according to claim 14,
wherein said solid constituent of said fluid consists in fine sand having a granulometry varying between 20 and 300 micrometers, and wherein said transmission of the warning signal is differed until a waveband of ⅓ of octave centered at a frequency selected among the frequencies of 25 Hertz and 200 Hertz is isolated, at a level exceeding said threshold amplitude value.

16. Control device according to claim 1,
wherein the granulometry of the fine sand occupies a range between 20 and 300 micrometers.

17. Hydrocyclone according to claim 4,
wherein the granulometry of the fine sand occupies a range between 20 and 300 micrometers.

18. Electromagnetic control device for controlling densimetric fluctuations of a fluid having solid and liquid constituents able to circulate across a hydrocyclone, the hydrocyclone allowing the segregation of the solid constituent of the fluid and comprising a tubular body having, at a first end, a fluid inlet and a first outlet for the liquid constituent of said fluid transverse to said fluid inlet, and at a second end, a second outlet for the solid constituent of said fluid, said control device being formed of:
a) electromagnetic means for remotely detecting an electromagnetic emission generated by the flow of the fluid in the hydrocyclone; and
b) a data processing unit, linked in a functional fashion to said electromagnetic means and being for transmitting a warning signal when said electromagnetic means detect a nonstandard amplitude variation of said electromagnetic emission.

19. Control device according to claim 18,
wherein said electromagnetic means consist in acoustic means, wherein said electromagnetic emission is a radiated noise, and wherein said warning signal is transmitted by said processing unit when said radiated noise develops in extreme bass frequencies.

20. Control device according to claim 19,
wherein the transmission of said warning signal is differed until said acoustic means detect in high amplitude a waveband of ⅓ of octave centered at a frequency selected among the frequencies of 25 Hz and 200 Hz.
